(19) United States
(12) Patent Application Publication
(10) Pub. No.: US 2010/0057659 A1
(43) Pub. Date: Mar. 4, 2010

(54) Determining a Target Career Path and Tasks to Achieve Same

(75) Inventors: Promise Phelon, San Jose, CA (US); Lisa A. Strand, Los Gatos, CA (US)

Correspondence Address: FENWICK & WEST LLP, SILICON VALLEY CENTER, 801 CALIFORNIA STREET, MOUNTAIN VIEW, CA, 94041, US

(73) Assignee: UPWARDLY MOBILE, INC., San Jose, CA (US)

(21) Appl. No.: 12/330,312

(22) Filed: Dec. 8, 2008

Related U.S. Application Data
(60) Provisional application No. 61/092,349, filed on Aug. 27, 2008.

(51) Int. Cl. G06N 5/02

(52) U.S. Cl. 706/46

(57) ABSTRACT

A career navigation system provides an automated way to counsel and/or coach a user on professional networking as it affects career development and/or career advancement. The career navigation system helps people both identify a path to their desired career destination and follow that path by means of various career management and network management tools and action items. A user is associated with a role model, such as a real-life person who has achieved the user's goal job. The role model's career path is customized to generate a roadmap for the user to follow in order to achieve his goal. Action items are generated and scheduled based on the roadmap, and the user is prompted to complete the items and track his progress.

### CROSS REFERENCE TO RELATED APPLICATION

This application claims the benefit of U.S. Provisional Application No. 61/092,349, filed Aug. 27, 2008, entitled “System and Method for Determining a Networking Style, Mapping to an UpModel and Generating Tasks and Goals for a User”, which is incorporated by reference in its entirety. This application is related to U.S. Provisional Application No. ______, filed Dec. 8, 2008, entitled “Career Navigation System”, which is incorporated by reference in its entirety.

### FIELD OF THE INVENTION

This invention relates generally to automated ways of counseling and/or coaching a user in a variety of areas including, for example, career advancement.

### BACKGROUND

Different people have different goals. Some people aspire to have a particular career. Whatever the goal, it can be difficult to develop a plan and action items to achieve it.

### SUMMARY

A career navigation system provides an automated way to counsel and/or coach a user on professional networking as it affects career development and/or career advancement. The career navigation system helps people both identify a path to their desired career destination and follow that path by means of various career management and network management tools and action items. A user is associated with a role model, such as a real-life person who has achieved the user's goal job. The role model's career path is customized to generate a roadmap for the user to follow in order to achieve his goal. Action items are generated and scheduled based on the roadmap, and the user is prompted to complete the items and track his progress.

### BRIEF DESCRIPTION OF THE DRAWINGS

FIG. 1 illustrates a flowchart of a process performed by a goal navigation system, according to one embodiment of the invention.

FIG. 2 illustrates a line graph that represents a career path, according to one embodiment of the invention.

FIG. 3 illustrates a line graph that represents a career path and various milestones, according to one embodiment of the invention.

FIG. 4 illustrates two line graphs, each of which represents a career path, according to one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Embodiments of the invention are now described with reference to the figures where like reference numbers indicate identical or functionally similar elements. Also in the figures, the left-most digits of each reference number correspond to the figure in which the reference number is first used.

### 1. Overview

Described herein are methods, systems, and computer program products that help people reach their goals. The goals can be of various types, such as career advancement, personal finance, romantic partnership, and other personal life goals. A “goal navigation system” uses the concept of a “role model” to help a person (“user”) identify a path to a desired goal destination such as a particular job, financial portfolio, romantic partnership, or other personal life goal.

In general, a role model represents a person to emulate and a life path to follow. In one embodiment, a role model represents a real person, and the role model's life path represents the actions performed and milestones achieved by that particular person. In this embodiment, a user would emulate the real person and follow that person's actual actions and milestones. The real person might be, for example, a person who has achieved the user's career, financial, romantic, or other life goals. In another embodiment, a role model represents a hypothetical person, which might be a composite of various people or might be entirely fictional.

The goal navigation system includes information about multiple role models and determines one role model for each user based on the user's goals, personal attributes, and prior achievements. The user is then associated with the determined role model and is able to customize the role model's life path if he wishes. The result is a “roadmap” customized for the user based on the emulatable milestones of the role model and specific forward-looking decisions of the user.

Based on this roadmap, the habits of the role model, and industry best-practices, the goal navigation system determines one or more goals or tasks (“action items”) and a schedule for performing them. The system notifies the user of the action items according to the schedule and enables the user to track his progress in completing them.

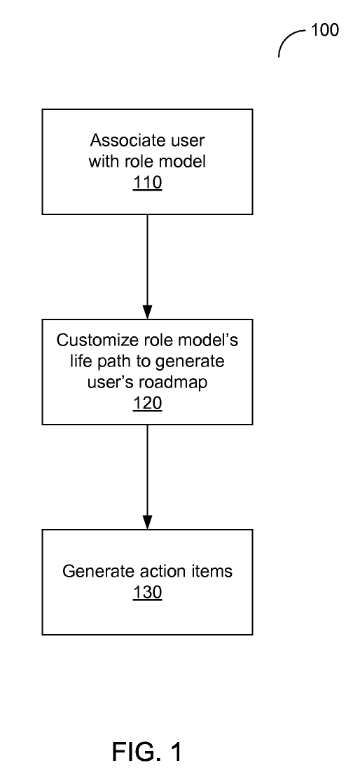

FIG. 1 illustrates a flowchart of a process performed by the goal navigation system, according to one embodiment of the invention. The process 100 comprises three phases. In the first phase, the system associates 110 a user with a role model. In the second phase, the system customizes 120 the role model's life path to generate the user's roadmap. In the third phase, the system generates 130 action items based on the roadmap.

As mentioned above, the goal navigation system can help a person achieve goals in such diverse areas as career advancement, personal finance, romantic partnership, and other personal life goals. For example, a “personal finance navigation system” can help a user define a plan that enables him to better manage his money with the goal of attaining greater wealth and being better prepared for retirement by building a customized roadmap, as well as specific life decisions each having a unique, pre-defined, and quantitative cost or benefit. This embodiment would entail the following steps: 1) A brief survey of the user to gather his financial history (salary, savings, investments), acceptable income to spending ratios, current budgets, money-management values, and long-term goals such as retirement dates and post-retirement quality of life. 2) Once the user attributes are known, a set of closely-matched role models (with successful investment strategies) will be suggested to the user. Models will be suggested based on the user's and models' attributes such as spending habits, desired length of career, and desired retirement quality. However, the user can select any model. 3) The user will select a model that may be an individual investor or a family or group. Users will be allowed to emulate the historical financial decisions and achievements. 4) This roadmap will be represented on a visual roadmap—horizontal (x) axis will represent years, and vertical (y) axis will represent the size of one's total assets in dollars. 5) The system will generate a tactical action plan and provide the user with daily spending goals and budgets, recommendations on ways to invest and manage money, and ongoing money-management habits that are obtained from his role model.

As another example, a “dating and romantic partnership navigation system” can help a user define a plan that enables him to find his ideal partner and build his ideal relationship by building a customized relationship roadmap, as well as specific life decisions each having a unique, pre-defined, and quantitative impact. This embodiment would entail the following steps: 1) A brief survey of the user to gather his relationship history, perspectives on children, life values (e.g., religion, faith, philanthropy, monogamy, sexual preference), education, interests, and long-term goals such as retirement, education, family. 2) Once the user attributes are known, a set of closely-matched role models (individuals, intimate couples, or families) with successful relationship strategies will be suggested to the user. Models will be suggested based on the user's and models' attributes such as communication habits, religion/faith, and long-term goals. However, the user can select any model. 3) The user will select a model that may be a married or committed couple. Users will be allowed to emulate the life decisions and trade-offs of this couple. 4) This plan will be represented on a visual roadmap—horizontal (x) axis will represent years together in a relationship, and vertical (y) axis will represent an index or econometric based on the couple's satisfaction and commitment. 5) The system will generate a tactical action plan and provide the user with recommendations on his ideal partner (based on the initial survey and partner of the role model), daily perspectives, and ongoing relationship and communication habits that are obtained from their role model relationship/couple.

As yet another example, a “life planning and personal achievement navigation system” can help a user define a plan that enables him to reach a personal life goal such as losing weight, overcoming fears or phobias, reaching personal milestones such as international travel, learning a language, or excelling at public speaking. In general, a personal life goal can be anything that enables a user to improve his life by achieving a broad or specific objective, with the goal of attaining greater life control or personal satisfaction. The life planning and personal achievement navigation system achieves this by building a customized roadmap, as well as specific life decisions each having a unique, pre-defined, and quantitative cost or benefit toward the user's desired end-point. This embodiment would entail the following steps: 1) A brief survey of the user to gather his current life perspective, his status (financial, relationship (family, friends and intimate), spiritual, financial), current barriers or challenges facing him, and long-term goals that establishes how he wishes to perceive his life and be perceived. 2) Once the user attributes are known, a set of closely-matched role models (with similar life paths) will be suggested to the user. Models will be suggested based on the user's and models' attributes. However, the user can select any model. 3) The user will select a model that may be an individual, a family, or group of individuals that represent a similar path (e.g., single mothers who have recovered from mastectomies to be remarried and continue their families). Users will be allowed to emulate the historical choices and achievements. 4) This roadmap will be represented on a visual roadmap—horizontal (x) axis will represent years, and vertical (y) axis will represent an index or econometric based on satisfaction, cholesterol level, weight, etc. 5) The system will generate a tactical action plan and provide the user with daily actions and exercises, recommendations on ways to manage energy and time, and ongoing life management habits and perspectives that are obtained from his role model.

A “career navigation system” will now be described in detail.

### 2. Career Navigation System—Introduction

In the early days of the Internet, job boards such as Monster.com were a great way for employers to find people and for people to find work. Now, however, only 16% of jobs are found through job postings. Finding a job by maintaining an online profile or conducting a broadcast campaign is even rarer (9% and 3%, respectively). With more than 75 million resumes on Monster.com, jobs in short supply, and employers teetering on the verge of layoffs all the time, there's a new way to fill jobs, a new way to find work.

According to a recent Jobvite survey, 78% of human resources and recruitment professionals use social networking sites to try to find job candidates, the most popular being LinkedIn (80%) and Facebook (36%) (Jobvite, Inc., Social Recruitment Survey Results, 2008, page 2). And, according to a recent ExecuNet study, 70% of executives who landed a new job said that networking was a major factor in their success (ExecuNet Inc., Executive Job Market Intelligence Report, 2008, page 13).

Networking skills are critical to successful career development and advancement. A person's network is going to be what empowers him and supports him now and in troubled times. So if he wants to move his career forward, then he needs to manage his network in relation to his career goals. He needs to know where he's going and how to use the right relationships to help him get there. Networking really does drive professional success, and effective networking can lead to dramatic increases in income.

What is needed is an automated way to counsel and/or coach a user on professional networking as it affects career development and/or career advancement. A “career navigation system” helps people reach further and higher in their careers by using the power of professional networks. Specifically, people are aided in building, nurturing, managing, and leveraging professional relationships that enable career growth. The career navigation system helps people both identify a path to their desired career destination and follow that path by means of various career management and network management tools and action items.

Like the other goal navigation systems described above, the career navigation system uses the concept of role models to help a person (“user”) identify a path to a desired goal. Here, the goal is a career destination such as the user's “dream job.” A role model might be, for example, an elite, high-earning professional who has achieved a very senior position. The life path of a role model would be a career path, including job positions held and milestones that affect career development (e.g., education). The user is able to customize the role model's career path if he wishes. The result is a “career roadmap” customized for the user based on the emulatable milestones of the role model and specific forward-looking decisions of the user.

### 3. Display of a Career Path

As mentioned above, a role model represents a person to emulate and a career path to follow. In one embodiment, the career navigation system represents a career path as a two-dimensional line graph. The scales for the dimensions can be either linear or logarithmic. One dimension represents “success.” The units that are used for this dimension depend on the meaning of success. For example, if the user is interested in overall job satisfaction, then success is defined as job satisfaction, and the units might be percentages from 0 (completely dissatisfied) to 100 (completely satisfied). As another example, if the user is interested in money, then success is defined as a quantity of money (e.g., total annual compensation), and the units might be dollar amounts. The dollar amounts can be actual amounts or amounts that have been adjusted for inflation. In fact, the success measurement can be any index or econometric value that represents one or more measurable quantities.

The other dimension represents time (e.g., particular years during a career such as “2000” and “2008”). Thus, a data point in the line graph would represent a particular amount of “success” (e.g., job satisfaction or annual compensation) at a particular point in time (a year). The data points would be connected by lines to illustrate the overall career trajectory.

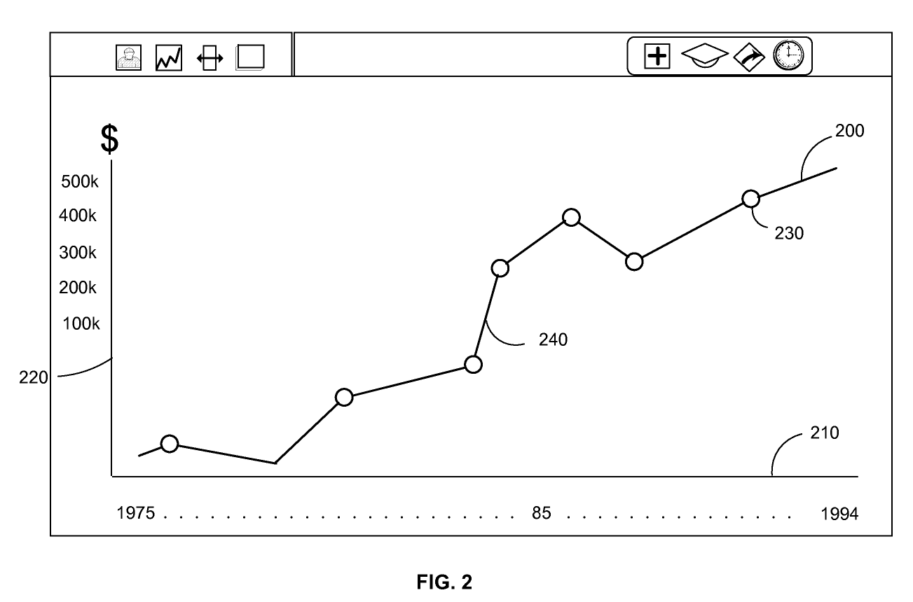

FIG. 2 illustrates a line graph that represents a career path, according to one embodiment of the invention. The line graph 200, which will be referred to as a “roadmap,” is defined by a Roadmapper module within the career navigation system. In FIG. 2, the horizontal axis 210 represents time (here, specific years), and the values range from 1975 to 1994. The vertical axis 220 represents success (here, annual compensation), and the values range from $0 k to $500 k. Thus, a data point in the line graph 200 represents a particular amount of money (annual compensation) at a particular point in time (a year). For example, the data point 230 represents annual compensation of $425 k in 1992.

In FIG. 2, the data points are connected by lines to illustrate the overall career trajectory. Each line represents a time period. For example, the line 240 represents the time period 1983-1984. In FIG. 2, the lines that connect the data points are unbroken to indicate that the corresponding time periods are in the past (and, therefore, that the data points reflect real-life data).

During a person's career, events (“milestones”) can occur that affect the career's trajectory. A milestone that promotes career advancement (e.g., receiving a promotion) is referred to as an “accelerator,” and a milestone that delays or inhibits career advancement (e.g., taking a hiatus from work) is referred to as a “decelerator.” In one embodiment, milestones are divided into three categories: educational, hiatus, and other.

Examples of educational milestones are: full-time Bachelor's degree; part-time Bachelor's degree; full-time Master's degree; part-time Master's degree; full-time MBA (or other specialized Master's program); part-time MBA (or other specialized Master's program); full-time JD; part-time JD; full-time MD (or other medical degree); part-time MD (or other medical degree); Ph.D. (or other 4+ year graduate degree); professional certification (or specific certification such as Microsoft certification or Cisco certification); 2-year professional education (pre- or post-grad); course on job-hunting skills; and course on effective networking skills.

Examples of hiatus milestones are: time off with contact to professional network; time off without contact to professional network; start a family; family leave; and travel the world.

Examples of other milestones are: get promoted (begin managing people); get promoted (begin managing projects); get promoted to <title> (industry-specific); accept lateral move to larger (or smaller) organization; accept promotion to larger (or smaller) organization; accept demotion to larger (or smaller) organization; change careers; switch industries (possibly including specific types of industries); move to a new region or country (possibly including specific regions or countries); quit to start a small business; quit to start a company; serve on external board of directors; author a book or blog or publish similar content; join a general business organization; join an industry-specific organization; join a philanthropic organization for business networking purposes; join an alumni association; establish or maintain an online community; establish a club or professional organization; learn a foreign language; live abroad; become a speaker (speak weekly/monthly/quarterly); solicit funding for a company; take a company public; and spend more (or less) time networking.

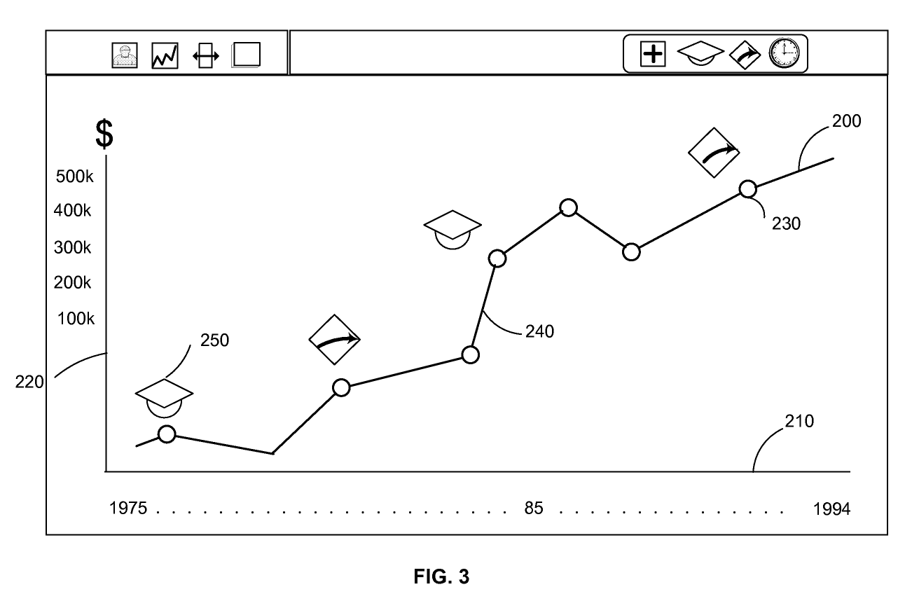

In one embodiment, milestones are displayed in addition to a roadmap. FIG. 3 illustrates a line graph that represents a career path and various milestones, according to one embodiment of the invention. In FIG. 3, four milestones are shown, and each milestone is represented by an icon. Since a milestone is an event, each milestone is associated with a particular point in time (e.g., when the event occurred). The location of a milestone icon relative to the time axis is determined by the point in time associated with the milestone itself. For example, the milestone icon 250 is located around “1976” on the time axis, which indicates that the milestone occurred in 1976.

In FIG. 3, two milestones are represented by graduation cap icons, and two milestones are represented by right turn road sign icons. In one embodiment, the type of icon associated with a milestone indicates the nature of that milestone. Table 1 lists example milestones and their associated icons. Note that different milestones and/or different icons can be used and displayed in conjunction with a career path line graph.

TABLE 1

| Milestones | Icons |
|---|---|
| Education (receiving a degree, certificate, or | Graduation cap |
| training) | |
| Lateral career move | Right turn road sign |
| Upward career move | Upper-right road sign |
| Publishing a book | Book |
| Changing employers | Upper-right road sign |
| Founding a company | Sun |
| Receiving a promotion | Up arrow |
| Completing a significant public speaking | Book |
| engagement | |
| Establishing a meaningful mentoring relationship | Up arrow |
| Time off to care for others (children, aging | Clock |
| parents) | |
| Taking a hiatus | Clock |
| Relocating | Upper-right road sign |
| Other | Upper-right road sign |

In one embodiment, if the user's cursor hovers over or near a milestone icon, information about the event represented by the icon is displayed. For example, if the cursor hovers over a graduation cap icon, information about the educational achievement is displayed (e.g., the name of the degree, the name of the school, and the graduation date). In another embodiment, if the user's cursor hovers over or near a career path curve, information about an event that occurred that year is displayed, where the year is determined by the location of the cursor with respect to the x-axis (which represents time).

4. Associating a User with a Role Model

As explained above with respect to the goal navigation system and FIG. 1, the career navigation system performs a process 100 in three phases. In the first phase, the system associates 110 a user with a role model. When this phase begins, the career navigation system has access to information about the user and access to information about one or more role models. If the career navigation system has access to information about only one role model, then that role model is assigned to the user automatically.

Assume that the career navigation system has access to information about multiple role models. In one embodiment, the system enables the user to browse or search the role models. For example, the user can view a role model's picture (if the role model represents a real-life person) and roadmap. The user might also be able to view the role model's career path (e.g., as a line graph as described above). The user chooses one role model, which is then associated with the user.

In another embodiment, a Role Model Matcher module within the career navigation system compares the user to the role models to determine how similar each role model is to the user. Specifically, the Role Model Matcher compares the information about the user to the information about the role models. In one embodiment, this information includes work history (such as a profile for each job or position that has been held). In another embodiment, this information includes a behavioral characteristic or personality trait (such as a “networking style”). A person can directly specify his own networking style. Alternatively, the person can be presented with specific questions, whose answers are used to determine the person's networking style. Examples of these questions are given in the Related Applications cited above.

Job profile information includes, for example, a function, an industry, and a role. In one embodiment, similar functions are grouped together and similar industries are grouped together, as shown in Tables 2 and 3, respectively. Note that different functions, industries, and/or groupings can be used for work history information.

TABLE 2

| Group | Functions |
|---|---|
| A | Administrative, legal, human resources, customer service |
| B | Communications/public relations, marketing, sales |
| C | Information systems, information technology |
| D | Accounting/finance, purchasing |
| E | Manufacturing/production/operations, engineering and research |
| F | Executive/management |

TABLE 3

| Group | Industries |
|---|---|
| 1 | Accounting, finance/banking, insurance, real estate |
| 2 | Aerospace, automotive |
| 3 | Agriculture/environment |
| 4 | Education, government, non-profit, utilities/energy |
| 5 | Health care |
| 6 | High tech-hardware, high tech-software, internet, manufacturing, |
| | petrochemical, telecommunications |
| 7 | Law |
| 8 | Media/publishing |
| 9 | Retail/distribution, transport |
| 10 | Services, travel |
| 11 | Other |

In one embodiment, roles include: contributor (no official project or people management), senior contributor (no official project or people management, more than 5 years in line of work), project manager (no direct reports), manager (with direct reports), senior manager, director, vice-president, senior/executive vice-president, c-level executive (CFO, CTO, COO, etc.), CEO/president/chairman, and self-employed.

In one embodiment, networking styles include Never Lose Touch, Diversity Is Key, Plan Strategically, and Give First. Never Lose Touch networkers are often the ones who reach out after losing contact with somebody. Chances are good they're the instigators of many a lunch outing with co-workers. They are defined by their proactive nature in reaching out to others and their generosity in helping them. Prioritizing who they keep in touch with is important, but so long as they are keeping their outreach in perspective, being a Never Lose Touch networker is a great way to keep their network ready for anything.

The power of Diversity Is Key networkers is being in touch with a wide variety of people. They value knowing lots of people from different walks of life and aren't afraid to reach out when needed. People with diverse networks do need to watch out to be sure the actions of their wide network is a positive reflection on themselves. Prioritizing whom to connect with, and how often, is important to people with this networking style—and by putting in a little effort, the power of their network will help them be ready for tough times.

Plan Strategically networkers are characterized by a laser-like focus on staying in touch with a small yet very select group of professionals. Their network might not be the largest, but they are well in-tune with whom they can help and who can help them in professional circles. They need to be very dedicated to keeping their networks close to them and constantly evaluating whether they have the right mix of people in their network. Reaching out to more professionals should be an ongoing activity for Plan Strategically networkers, such that their network stays fresh and they remain driven to help and be helped in times of trouble.

Generosity goes a long way in the realm of professional networking, and Give First networkers put a lot of attention to the amount they offer help to others. They are characterized by their willingness to help others, and they are careful about choosing who is a part of their network. Give First networkers do need to choose the members of their network carefully. They can't afford to be giving to a network that is unwilling or unresponsive to their own needs too. By following their golden rule—the best way to receive is to give first—they'll effectively weather tough times.

Recall that the Role Model Matcher compares the information about the user to the information about the role models. A numerical score represents how similar a particular role model is to a particular user. In one embodiment, a higher similarity score represents a higher degree of similarity. In one embodiment, the Role Model Matcher determines a similarity score for each role model. The Role Model Matcher can then identify the “most-similar” role model (e.g., the role model with the highest similarity score) and associate this role model with the user.

Alternatively, the Role Model Matcher can identify n role models (e.g., 3 role models) and the user can choose between them. In one embodiment, the n role models are the n role models with the highest similarity scores. In another embodiment, the n role models with the highest similarity scores are identified, but then this list is modified (if necessary) to ensure a proper balance of gender, job profile (industry, function, role), and/or networking style. The user then chooses a role model from the modified list.

The Role Model Matcher determines a similarity score for a particular role model based on information about the user and information about the role model. Specifically, the networking styles and job histories of the user and role model are compared. The similarity score begins at zero and is computed as follows:

Networking Style—The networking style of the user is compared to the networking style of the role model. If the user and the role model have the same networking style, then 100 points are added to the similarity score. If the user and the role model have different networking styles, then 0 points are added to the similarity score.

Job History—Job profiles of the user are compared to job profiles of the role model on a pairwise basis. For example, a first job profile of the user is compared to each job profile of the role model. Then, a second job profile of the user is compared to each job profile of the role model. For each job profile pair that has the same function (see above), 100 points are added to the similarity score. For each job profile pair where the functions are not identical but do fall within the same group (see Table 2), 25 points are added to the similarity score. For each job profile pair that has the same industry (see above), 100 points are added to the similarity score. For each job profile pair where the industries are not identical but do fall within the same group (see Table 3), 25 points are added to the similarity score.

In one embodiment, roles are also compared. For each job profile pair that has the same role (see above), 5 points are added to the similarity score. The “role” points are small compared to the “function” points and the “industry” points and are meant to serve as a tie-breaker (e.g., between two role models with close similarity scores).

Table 4 summarizes how a similarity score is determined.

TABLE 4

| Information | Points to add to similarity score |
|---|---|
| Style | 100 if match; 0 if not match |
| Function | 100 if match; 25 if in same group |
| Industry | 100 if match; 25 if in same group |
| Role | 5 if match |

### 5. Customization of a Role Model's Career Path

In the second phase, the system customizes 120 the role model's career path in order to generate the user's roadmap. When this phase begins, a role model has been associated 110 with the user. Also, the career navigation system has access to information about the user and access to information about the associated role model.

A Roadmapper module within the career navigation system uses the career path of the associated role model as a starting point for generating the user's roadmap. Recall that the user is planning his (future) career based on the role model's (past) career. Thus, the years during the role model's career will not match the years during the user's career. In order to compensate for this, the Roadmapper shifts the career path of the role model forward in time so that the role model's career path starts when the user's career starts. In one embodiment, if career success is defined as a quantity of money (e.g., total annual compensation), then the Roadmapper adjusts the monetary units of the role model's career path to account for present-day market and macroeconomic conditions.

The length of the role model's career and the (desired) length of the user's career might not match. In order to accommodate this, the Roadmapper increases or decreases the length (in time) of the career path of the role model so that the length of the role model's career path matches the length of the user's career path.

At this point, two career paths exist with the Roadmapper: a) the original career path of the role model and b) the role model's career path as modified to compensate for the user's career's start year and length (referred to herein as the “modified role model's career path” or MRMCP). The Roadmapper generates a third career path that corresponds directly to the user's career (past, present, and future). The success values of the “past” and “present” portions (i.e., the y-axis of the line graph) are based on information about the user's actual career, such as actual success measures (e.g., annual compensation) and milestone events. The success values of the “future” portion are estimated or forecast.

Specifically, the success values of the future portion are based on a) the present portion, b) the assumption that the user will follow in the role model's footsteps (e.g., with respect to milestones and networking/career development tasks), and c) the assumption that the user will experience an average salary growth for a professional in a particular job. In one embodiment, where success is defined as annual compensation, the success values of the future portion are determined as follows:

The current success value (annual compensation) is used as the starting point and increased at a rate expected for a person with the user's job profile (function, industry, and/or role). The rate is determined based on past employment data that has been collected (for example, by the U.S. Department of Labor's Bureau of Labor Statistics and/or the U.S. Department of Commerce's Census Bureau).

Effects of the milestones in the MRMCP are also taken into account. For example, if the MRMCP includes an educational milestone of earning a particular degree, then the user is assumed to also earn that degree at the same point in time (relative to the entire career span). If the MRMCP includes taking a hiatus from work (e.g., to start a family), then the user is assumed to also take a hiatus at the same point in time (relative to the entire career span). If the MRMCP receives a promotion and thereby takes on a new role, then the user is assumed to also receive a promotion and thereby take on a new role at the same point in time (relative to the entire career span).

Each of these milestones affects the user's career path differently. For example, earning a degree will generally increase annual compensation, while taking a hiatus will generally not affect compensation (or might decrease compensation, depending on the length of the hiatus). Appendix A describes various milestones and their forecasted effects on annual compensation.

In one embodiment, dollar amounts are adjusted for the user's geographical area (e.g., based on ZIP code). The adjustment is determined based on past employment data that has been collected (for example, by the U.S. Department of Labor's Bureau of Labor Statistics' National Compensation Survey—Relative Occupational Pay). Dollar amounts can also be adjusted based on the compound annual growth rate (CAGR), which varies by job function.

The Roadmapper displays the modified role model's career path and the user's career path (past, present, and future) as line graphs. In one embodiment, in the future portion of the user's career path, the lines are dashed to indicate that they are estimates or forecasts (and, therefore, that the data points reflect planned or projected data).

Each of the two line graphs can be displayed using a different set of axes. Alternatively, both line graphs can be displayed using the same set of axes. In one embodiment, when both line graphs are displayed using the same set of axes, there are two sets of values shown on the time axis—one set containing years that correspond to the role model's career span and one set containing years that correspond to the user's career span.

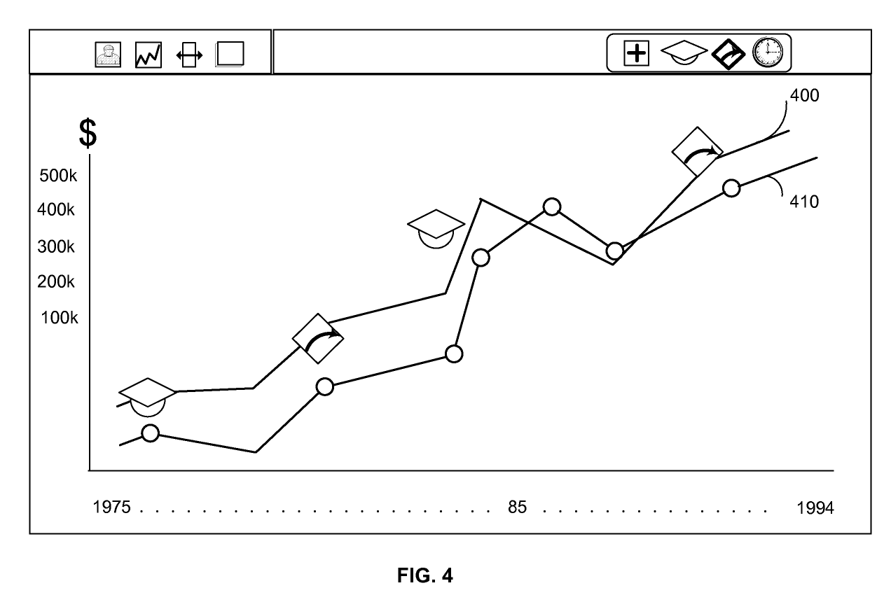

In FIG. 4, both line graphs use the same set of axes. FIG. 4 illustrates two line graphs, each of which represents a career path, according to one embodiment of the invention. The line graph 400 represents the MRMCP. The line graph 410 represents the user's career path. In FIG. 4, the future portion of the user's career path uses dashed lines to indicate that they are estimates or forecasts. Note that the future milestones in the user's career path match the corresponding milestones in the MRMCP.

The Roadmapper enables the user to modify the future portion of his career path if he so wishes. For example, the Roadmapper enables the user to add, remove, or reposition milestones. After a change is made, the future portion of the user's career path is recalculated to reflect the changed circumstances. In this way, the user can try out different scenarios regarding his future and see how each scenario affects his success value (e.g., annual compensation). This forecasting enables the user to evaluate the impact of real-life decisions on his career and gives the user the ability to make decisions that positively impact his career.

In one embodiment, the line graphs for multiple scenarios can be shown simultaneously so that the user can compare them more easily. For example, two line graphs can be shown simultaneously—one line graph that reflects the user earning an MBA and another line graph that reflects the user not earning an MBA (or, perhaps, earning the MBA but at a different point in time).

Thus far, it has been assumed that the highest title of the role model's career corresponds to the highest title that the user wants to achieve. However, this need not be the case. In one embodiment, the Roadmapper enables the user to re-map his career endpoint. For example, the user can specify any point during the role model's career path (i.e., not just the endpoint) and use that point as the user's career end point. For example, the role model might have retired as the CEO of a Fortune 500 corporation, but the user's career goal is to become the VP of a Fortune 500 class company. The role model was promoted to VP in 1985 and then promoted to CEO in 1993 and then retired from her CEO position in 2005. The user can “remap” his career over the role model's career until 1985, without the 1985 to 2005 period.

The Roadmapper also enables a user to add annotations to his career path (e.g., like sticky notes).

### 6. Generation of Action Items

In the third phase, the system (specifically, a Task Engine module within the system) generates 130 action items based on the user's roadmap and the associated role model. For example, which action items are generated will differ based on the user's tenure in his industry, how long before he expects to make a career transition (e.g., change employers), past networking activities that he has performed, and events that he has decided to attend.

In one embodiment, the Task Engine generates items based on user preferences such as: how much time to spend networking (less time<->more time), how often to attend industry events (less often<->more often), how often to attend social events (less often<->more often), how to keep in touch (formal/written on paper<->casual/email or instant messenger), and how often to change jobs (less often<->more often). For example, each of these preferences can be set by moving a slider control along a spectrum between the two extremes.

Action items are part of a larger Career Action Plan. A Career Action Plan (CAP) includes information organized into calendar items and daily to-do lists. In one embodiment, CAP information can be integrated with other software applications such as Microsoft Outlook. Calendar items can include, for example, registration deadlines for upcoming industry events. To-do list items can include, for example, reminders to reconnect and follow-up with key network members face-to-face or over the phone or email.

Performing these action items will develop and strengthen the user's relationships with people crucial to his career success. Action items include, for example, networking goals, activities, and tasks such as making phone calls, sending emails, attending meetings or conferences, taking classes, updating network members' contact information, and reading articles or books. In one embodiment, the Task Engine recommends content for the tasks (e.g., what to discuss during a phone call or what to write in an email) such as a status update, birthday wishes, or get well soon sentiments.

In one embodiment, the Career Action Plan has access to an address book that includes the user's contacts (members of the user's network). The Tasks Engine populates the action items with information from these contacts. For example, an email action item is scheduled based on the birthday of a key network member, and the action item includes the member's email address.

In one embodiment, the Task Engine recommends relevant industry functions and networking events based on the user's industry, personal interests, and networking style. If the user accepts an event, the Task Engine adds the event to the calendar, generates recommend pre-event tasks (e.g., booking a plane ticket and hotel room), and reminds the user after the event is over to follow-up with people he met at the event.

The Task Engine not only generates action items but also schedules them. If the user does not want to perform an item on the scheduled date, he can snooze the item or move it to a later date. When the user completes an item, he marks it as “complete” and can also enter a completion date. In one embodiment, the scheduled tasks are updated upon any of the following events: completion of a task; association of the user with a different role model; change in the user's career transition state (e.g., when user expects to switch jobs); addition of an event; and modification of the user's roadmap (e.g., adding, removing, or modifying a milestone).

Recurring items can have different frequencies such as daily, weekly, monthly, quarterly, and annually. Future dates of a recurring item can be fixed (regardless of when the previous task was completed) or dependent (based on the completion date of the previous task). In one embodiment, task scheduling is adjusted or weighted based on which items the user has completed in the past.

The Task Engine also prioritizes action items so that more important items are scheduled (and must be completed) before less important items. More important items can also recur more frequently than less important items. Each item is associated with a time period that indicates how long it takes to complete the item.

In one embodiment, tasks are scheduled as follows: 1) Weekly “maintenance tasks” (basic networking tasks) are scheduled, up to a maximum of 4 hours per week total. If these tasks are not completed, they roll over to the next week. If they are completed, they are added again a fixed number of weeks later, based on a prescribed frequency. (max out at 4 hrs/wk). 2) Tasks with fixed dates are scheduled (e.g., attending a particular meeting). 3) Remaining tasks are scheduled (in order based on priority) until the total time spent networking maxes out. Any completed task is moved to the end of its respective list.

In one embodiment, scheduled tasks are displayed in a tabular format, where each task is a row in the table. Columns represent characteristics of tasks, such as event type, description, time required to complete, priority, actions (e.g., compose email), and completion information (e.g., whether completed and when). The rows (tasks) can be ordered (sorted) based on any of these characteristics. All tasks can be displayed or they can be filtered based on when they are due (right now, this week, this month, long term, or already completed).

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

### Appendix A

The numbers given below are just examples. In one embodiment, the numbers are reviewed and updated on a regular basis to reflect current salary and job demand trends and as reliable data sources are discovered.

The annual compensation after a Bachelor's degree is increased to a level expected for a person who earns that degree and has a particular job function. The level is determined based on past employment data that has been collected (for example, by the National Association of Colleges and Employers (NACE)). For example, the starting salary of someone with a Bachelor's degree and a job function of Accounting/Finance and a job role of “contributor” is $48,095. Table A.1 shows starting salaries for people with Bachelor's degrees with various job functions and job roles of “contributor.”

TABLE A.1

| Function | Starting salary |
|---|---|
| Accounting/Finance | $48,085 |
| Administrative | $36,419 |
| Communications/Public Relations | $36,419 |
| Customer Service | $36,419 |
| Engineering and Research | $60,416 |
| Executive/Management | $45,915 |
| Human Resources | $36,419 |
| Information Systems/Information Technology | $52,418 |
| Legal | $36,419 |
| Manufacturing/Production/Operations | $36,419 |
| Marketing | $42,053 |
| Purchasing | $48,085 |
| Sales | $45,915 |

The annual compensation before a Master's degree is increased at a rate expected for a person who earns that degree and has a particular job function. The rate is determined based on past employment data that has been collected. For example, the salary increase due to earning a Master's degree for someone with a job function of Accounting/Finance is 12%. Table A.2 shows salary increases for people earning Master's degrees with various job functions.

TABLE A.2

| Function | Salary increase |
|---|---|
| Accounting/Finance | 12% |
| Administrative | 13% |
| Communications/Public Relations | 12% |
| Customer Service | 13% |
| Engineering and Research | 12% |
| Executive/Management | 11% |
| Human Resources | 12% |
| Information Systems/Information Technology | 12% |
| Legal | 11% |
| Manufacturing/Production/Operations | 12% |
| Marketing | 13% |
| Purchasing | 12% |
| Sales | 12% |

The annual compensation after a Ph.D. degree is increased to a level expected for a person who earns that degree and has a particular job function. The level is determined based on past employment data that has been collected (for example, by the U.S. Department of Labor's Bureau of Labor Statistics). For example, the starting salary of someone with a Ph.D. degree and a job function of Accounting/Finance is $125,400. Table A.3 shows starting salaries for people with Ph.D. degrees with various job functions.

TABLE A.3

| Function | Starting salary |
|---|---|
| Accounting/Finance | $125,400 |
| Administrative | $125,400 |
| Communications/Public Relations | $94,100 |
| Customer Service | $94,100 |
| Engineering and Research | $133,920 |
| Executive/Management | $125,400 |
| Human Resources | $125,400 |
| Information Systems/Information Technology | $116,460 |
| Legal | $125,120 |
| Manufacturing/Production/Operations | $125,400 |
| Marketing | $94,100 |
| Purchasing | $125,400 |
| Sales | $125,400 |

The annual compensation before a certificate is increased at a rate expected for a person who earns that certificate. The rate is determined based on past employment data that has been collected. For example, the salary increase due to earning a certificate is 6%.

The annual compensation after a role change is adjusted to a level expected for a person who has that particular role with a particular job function. The level is determined based on past employment data that has been collected. For example, the starting salary of someone whose role is Vice-President and whose job function is Accounting/Finance is $121,050. Starting salaries for people with various roles and job functions are given in the Related Applications cited above.

Statistics are also available to predict future annual compensation, as opposed to just salary (e.g., the U.S. Department of Labor's Bureau of Labor Statistics' National Compensation Survey—Average Annual Compensation).

What is claimed is:

1. A method for advising a user, comprising:
identifying a role model for the user to emulate; and
determining, based on the identified role model, a set of action items for the user to perform.

2. The method of claim 1, wherein the role model is identified based on a set of attributes related to the user.

3. The method of claim 2, wherein the set of attributes related to the user comprises a personal characteristic of the user.

4. The method of claim 2, wherein the set of attributes related to the user comprises an achievement of the user.

5. The method of claim 2, wherein the set of attributes related to the user comprises a goal of the user.

6. The method of claim 5, further comprising determining, based on the goal of the user, a second set of action items for the user to perform.

7. The method of claim 1, further comprising determining, based on the identified role model, a roadmap for the user.

8. The method of claim 7, wherein the roadmap comprises a set of goals and a schedule for achieving the set of goals.

9. The method of claim 8, wherein the set of goals is based on a goal defined by the user.

10. The method of claim 7, further comprising enabling the user to modify the roadmap.

11. The method of claim 7, further comprising determining, based on the roadmap, a second set of action items for the user to perform.

12. The method of claim 1, wherein the set of action items for the user to perform concerns career advancement.

13. A method for determining user-specific career advice, the method comprising:
identifying a role model for the user to emulate;
customizing a career path of the role model based on information concerning the user; and
determining, based on the customized career path, a set of action items for the user to perform.

14. The method of claim 13, wherein the role model is identified based on a set of attributes related to the user.

15. The method of claim 14, wherein the set of attributes related to the user comprises a networking style of the user.

16. The method of claim 14, wherein the set of attributes related to the user comprises a job history of the user.

17. The method of claim 14, wherein the set of attributes related to the user comprises a job desired by the user.

18. The method of claim 13, further comprising determining, based on the identified role model, a roadmap for the user.

19. The method of claim 18, wherein the roadmap comprises a set of goals and a schedule for achieving the set of goals.

20. A computer program product for advising a user, the computer program product comprising a computer-readable storage medium containing computer program code for:
identifying a role model for the user to emulate; and
determining, based on the identified role model, a set of action items for the user to perform.
